(19) United States
(12) Patent Application Publication
(10) Pub. No.: US 2025/0207726 A1
(43) Pub. Date: Jun. 26, 2025

(54) A METHOD OF STORING ETHANE

(71) Applicant: EQUINOR ENERGY AS, Stavanager (NO)

(72) Inventors: Arild SAMUELSBERG, Hauggesund (NO); Per LOTHE, Førresfjorden (NO)

(21) Appl. No.: 18/845,533

(22) PCT Filed: Mar. 15, 2023
(86) PCT No.: PCT/NO2023/050058

§ 371 Date: Sep. 10, 2024

(30) Foreign Application Priority Data
Mar. 15, 2022 (GB) 2203595.0

(51) Int. Cl. F17C 1/00; F17C 5/06; F17D 3/12

(52) U.S. Cl. CPC F17C 1/002; F17C 5/06; F17D 3/12; F17C 2201/0119; F17C 2201/032; F17C 2221/032; F17C 2223/0153; F17C 2223/035; F17C 2227/0142; F17C 2270/0105; F17C 2270/0171

(57) ABSTRACT

A method of storing ethane includes storing ethane in a number of storage pipes as a liquid at ambient temperature conditions. The storage pipes may be provided on a tanker.

The present invention relates to a method of storing ethane and to a corresponding storage. The method further extends to a method of transporting ethane utilising said storage and to a transportation vehicle comprising said storage. Further, the invention extends to a method of enhancing hydrocarbon production using ethane storage.

It is known to inject ethane (C₂H₆) into dry gas (i.e. a hydrocarbon gas that consists substantially of methane) in order to increase its energy content and thus its value. To permit such injection it is required to obtain, store and transport ethane to a site of the dry gas (e.g. a dry gas pipeline).

Current modalities utilised for the storage and transportation of ethane comprise liquefying the ethane at atmospheric pressure conditions, e.g. 1 atmosphere (101325 Pa), and storing and transporting the liquid ethane as such. This requires temperature conditions significantly below atmospheric temperature conditions. For example, at a pressure of 1 atmosphere the temperature would have to be approximately −90° C. to obtain and maintain ethane as a liquid. Thick steel-walled storage tanks are utilised to suitably store and transport liquid ethane at ambient pressure conditions. These tanks provided the requisite insulation to maintain the ethane as a liquid at ambient pressure conditions.

Once the liquid ethane at ambient pressure conditions is transported to the site of the dry gas, the liquid ethane needs to be heated for its suitable mixing with the dry gas. The ethane will also usually need to be pumped and/or compressed to bring it up to pressures suitable for introduction into the dry gas (which, in the example of a dry gas pipeline, may be at 180 barg). These heating, compression and pumping processes are associated with a large energy input and also require a relatively large amount of equipment. As such they are costly and in some situations, e.g. in an offshore setting, it may not be technically viable to implement these processes.

Furthermore, the initial processes involved in liquefying the ethane and maintaining the ethane as a liquid at ambient pressure conditions are both energy and equipment intensive. Consequently, to date, it has not typically been viable, both technically and commercially, to inject ethane into dry gas to improve its energy content. In particular, it has been unviable to do so at an offshore dry gas pipeline.

Improvements in ethane handling are thus desired which enable a more viable means of increasing energy content of dry gas.

In accordance with a first aspect, there is provided a method of storing ethane, the method comprising storing ethane in a plurality of storage pipes as a liquid at ambient temperature conditions.

The term ‘storage pipe’ refers to a storage container formed from (i.e. comprising) a length of pipe, which has been closed at each end, optionally by a hemispherical cap or dome that has, for example, been welded to the end of the pipe. Accordingly, the storage pipes are highly elongate, typically having a length-to-diameter ratio of at least 20.

The method of the first aspect makes use of storage pipes to permit storage of the ethane as a liquid at ambient temperature conditions. Using storage pipes compared to, e.g., conventional tank storage (i.e. vessel storage) as the basis for storage of ethane is advantageous since it is associated with a significantly lower capital and operational expenditure, particularly in the context of storing ethane at elevated pressures and ambient temperature conditions as is required when storing the ethane as a liquid at ambient temperature conditions.

Conventional ‘tank’ type storage solutions, which as discussed above have been implemented in storing liquid ethane at ambient pressure conditions, require thick steel walled tanks. These tanks are expensive and technically demanding to provide (given the large amount of material typically required), and are also expensive and technically demanding to handle and transport given their weight (again, given the large amount of material required). The requisite wall thickness (and hence weight of the tank) also limits the size of the tank that can be used, meaning that the volume of ethane stored therein is limited. The large wall thickness also occupies a large volume of space, which in turn results in tank type storage utilising available space for storage inefficiently.

In contrast, pipe storage is relatively inexpensive to provide because standard, ‘off-the-shelf’ pipes may be used to manufacture them. Moreover, for a given volume of storage, pipe storage can have a comparatively smaller wall thickness. Thus, a given volume of liquid ethane can be stored using a comparatively lower total weight of storage tank material using pipe storage and can be achieved at a lower capital expenditure. The relatively smaller wall thickness of pipe storage means that, for a given volume of ethane, the total space occupied using the pipe storage solution is smaller. Thus, pipe storage provides a more viable solution, both technically and commercially, for storage of ethane and provides a more viable foundation for enhancing hydrocarbon production through injection of ethane into dry gas (more on this below).

The method of the first aspect requires that the ethane is stored in a liquid state at ambient temperature conditions. Ambient temperature conditions may be any temperature between 0° C. and 40° C., more typically between 0° C. and 25 C. The skilled person will appreciate that in order to maintain the ethane as a liquid at ambient temperature conditions it requires the ethane to be pressurised to above ambient pressure conditions. The pressure conditions that the ethane is stored at may therefore be between 35 barg to 49 barg, optionally 40 barg to 45 barg, with the exact pressurised condition required being determined by the ambient temperature conditions and the requirement that the ethane must be in a liquid state. The pressurised conditions may further be affected by other factors, e.g. the tolerances of the storage pipe and/or the tolerance of the equipment used for loading and unloading the ethane into the storage pipes.

It is advantageous to store ethane as a liquid at ambient temperature conditions as opposed to ambient pressure conditions (and very low temperature conditions). This is because it is technically more challenging and labour intensive to liquefy and store ethane as a liquid at ambient pressure conditions given the very low temperatures involved. There is significant complexity and expenditure, both operational and capital, associated with the equipment, personnel and processes required to produce and maintain ethane as a liquid at such temperature conditions and at ambient pressure conditions. Moreover, in certain settings, e.g. an offshore scenario as discussed as an optional feature of the invention below, limited space and infrastructure also means that it may not be viable to produce liquefied ethane at ambient pressure conditions. The advantageous storage pipes of the invention, offering an effective storage solution for liquid ethane at ambient temperature conditions, are also not suitable for storing liquefied ethane at ambient pressure conditions given they cannot provide the requisite temperature control. Storing ethane as a liquid at ambient temperature conditions thus provides a more viable foundation for enhancing hydrocarbon production by injection of ethane into dry gas as discussed in greater detail below.

Each of the storage pipes may have a nominal diameter of between 40-60 inches (1.0 m-1.5 m). Optionally, the pipe may have a nominal size of 42 inches (1.1 m) or 56 inches (1.4 m), or may have any nominal size in the range of 42 inches (1.1 m) to 56 inches (1.4 m).

A vessel having a nominal diameter greater than about 56-60 inches (1.4 m-1.5 m) would typically be considered by the skilled person as a conventional tank (or pressure vessel) that is distinct from a pipe. This consideration is also true in the context of the current invention, whereby any vessel having a nominal diameter of greater than about 56-60 inches (1.4 m-1.5 m) would not be considered as a pipe. Each storage pipe may comprise or be formed from a pipe that is an X42, X46, X52, X56, X60, X65, X70 or X80 pipe in accordance with the API SPEC 5L specification.

As noted above, the storage pipes are highly elongate. Accordingly, each storage pipe of the first and/or second sets may have a length of between 10 m to 30 m, for example 12 m, 24 m or 26 m.

Each of the storage pipes may be formed from rolled pipes with, optionally, a single longitudinal seam. Such pipes are commonly available as ‘off-the-shelf’ type components and are typically inexpensive.

The storage pipes will be configured for storing ethane at an elevated pressure given the ambient temperature conditions of the liquid ethane to be stored. The storage pipes may be configured to store the ethane at 35 barg and 49 barg, for example between 40 barg and 45 barg. The exact pressurised conditions that the storage pipes are configured to store the ethane at may be selected dependent on the ambient temperature of the liquid ethane to be stored therein, the tolerances of the storage pipe and/or the tolerance of the equipment used for loading and unloading the ethane into the storage pipes.

Each of the storage pipes may be arranged vertically (i.e. the primary axis of the storage pipes may be arranged vertically or substantially vertically) or horizontally (i.e. the primary axis of the storage pipes may be arranged horizontally or substantially horizontally). The storage pipes may comprise a combination of horizontally and vertically arranged storage pipes. Each or some of the storage pipes may be arranged in any other orientation between horizontal and vertical.

The method may comprise the step of liquefying ethane at ambient temperature conditions prior to the step of storing the ethane.

Ethane, as will be appreciated, is a hydrocarbon with a chemical formula of C₂H₆.

The plurality of storage pipes may be provided on/at a facility. That is, a facility may comprise the plurality of storage pipes. The facility may be considered a storage facility. In an offshore scenario, the facility may be an offshore floating facility. The offshore floating facility may take the form of an offshore floating platform, vessel or spar buoy. The offshore floating facility may be unmanned. The offshore facility need not be floating however, it may be fixed (e.g. a fixed type platform).

The plurality of storage pipes may be provided on a transportation vehicle. In a land based (i.e. onshore) setting, the vehicle may be a goods vehicle (e.g. a light or heavy goods vehicle). In an offshore setting, the vehicle may be a ship, vessel and/or tanker.

The step of storing ethane in the plurality of storage pipes as a liquid at ambient temperature conditions may comprise storing only, or substantially only, ethane in the plurality of storage pipes as a liquid at ambient temperature conditions. That is to say, only (i.e. exclusively) ethane, or only ethane save for trace amounts of other components, is/are stored within the storage pipes. For example, the contents of the storage pipes may comprise upwards of 90%, 95%, 99% or 99.9% ethane (by volume, weight or molar amount). Optionally, the contents of the storage pipes comprise 100% ethane.

In a second aspect of the invention, there is provided a method of transporting ethane, the method comprising storing ethane in a plurality of storage pipes provided on a transportation vehicle as a liquid at ambient temperature conditions; and transporting the ethane with the vehicle.

The transportation vehicle of the second aspect may correspond to the transportation vehicle discussed above in connection with the first aspect. In particular, the transportation vehicle may be a ship, vessel and/or tanker.

Prior to the step of storing ethane, the method of the second aspect may comprise loading the ethane onto the transportation vehicle comprising the plurality of storage pipes. In an example, this may comprise loading ethane onto the transportation vehicle from an onshore or offshore production facility/system.

The method of the second aspect may comprise/be in accordance with any compatible optional features of the first aspect. In particular, the storage pipes of the second aspect may be in accordance with the storage pipes as described above.

The method of the second aspect may comprise liquefying the ethane to form liquid ethane at ambient temperature conditions before the step of storing the ethane and optionally before or after the optional step of loading the ethane onto the transportation vessel.

In a third aspect of the invention, there is provided a method of enhancing hydrocarbon production, the method comprising: storing ethane in a plurality of storage pipes provided on a transportation vehicle as a liquid at ambient temperature conditions; transporting the ethane with the vehicle to a site of a dry gas pipeline; and injecting the ethane into the dry gas pipeline.

The method of the third aspect is advantageous since it permits enhancement of hydrocarbon production, and in particular enhancement of the energy content of the produced hydrocarbons. As is known, ethane has a higher energy content than methane (the primary constituent of dry gas) and thereby, by enabling injection of ethane into the dry gas, the energy content of the dry gas is substantially increased.

Moreover, as will be appreciated from the above discussion, the method of the third aspect is enabled in a technically and commercially viable manner through use of the storage pipes and through storage and transportation of the ethane as a liquid at ambient temperature conditions. Thus, this enhancement of energy content of the produced hydrocarbons (i.e. dry gas) is done so in both a commercially and technically viable way.

Dry gas is a hydrocarbon gas product that consists substantially of methane (CH₄). That is to say, dry gas predominantly and, optionally, almost or entirely exclusively, comprises methane.

The dry gas pipeline implicitly comprises dry gas therein. The dry gas may be flowing therethrough at, for example, pressures of 150 barg to 200 barg. For example, the dry gas may have a pressure of 179 barg or 180 barg.

The dry gas pipeline may be an offshore dry gas pipeline, optionally an offshore subsea dry gas pipeline. As such, the transportation vehicle may be a ship, tanker or vessel. The method may comprise injecting the ethane into the offshore subsea dry gas pipeline via a turret connected via a conduit (e.g. a riser) to the offshore subsea dry gas pipeline, wherein the turret is situated at sea level.

The dry gas pipeline may be land based (i.e. onshore). The method may comprise injecting the ethane into the land based dry gas pipeline via a hose connected to the dry gas pipeline.

The method of the third aspect may comprise injecting the ethane into the dry gas pipeline directly from the transportation vehicle. For example, in an offshore scenario, the method may comprise injecting the ethane directly from a ship, vessel or tanker to an offshore dry gas pipeline, optionally via a turret as discussed above.

Alternatively, the method may comprise offloading the ethane from the transportation vehicle to a second plurality of storage pipes provided at a facility situated at the site of the dry gas pipeline, storing the ethane as a liquid at ambient temperature conditions in the second plurality of storage pipes at the facility, and wherein the step of injecting the ethane into the dry gas pipeline comprises injecting the ethane from the second plurality of storage pipes at the facility and into the dry gas pipeline. The optional facility of the third aspect may correspond to the optional facility discussed above in connection with the first aspect of the invention. For example, in an offshore scenario, the facility may comprise an offshore floating facility situated at the site of an offshore dry gas pipeline (e.g. floating at sea level above a subsea offshore dry gas pipeline). The facility is advantageous since it provides a temporary or ‘buffer’ storage for ethane prior to injection to the dry gas pipeline, which may be used to provide effectively continuous injection of ethane to the dry gas pipeline.

The step of injecting ethane into the dry gas pipeline may comprise pumping the ethane into the dry gas pipeline with a booster pump. This step may be required in scenarios where the pressure of the dry gas within the dry gas pipeline (or at least at the portion of the dry gas pipeline where the ethane is injected) is higher than the pressure of the liquid ethane that is stored and transported within the storage pipes. For example, the suction of a compressor associated with the dry gas pipeline may create a pressure of 150 barg to 200 barg within the dry gas pipeline, optionally 179 barg or 180 barg. This would conventionally be higher than the pressure of the liquid ethane in the storage pipes. The method may thus comprise pumping the liquid ethane to 150 barg to 200 barg, optionally 179 barg to 180 barg with the booster pump.

The step of injecting the ethane into the dry gas pipeline may comprise static mixing of the ethane with the dry gas in the dry gas pipeline. This may comprise use of an appropriate static mixer. The step of static mixing may enable vaporisation of the ethane into droplets which permits it to better blend in with the dry gas in the pipeline.

The method of the third aspect may comprise/be in accordance with any compatible optional features of the first and/or second aspects. In particular, the storage pipes of the third aspect may be in accordance with the storage pipes as described above.

The step of storing in the method of the third aspect may be in accordance with the method of the first aspect, optionally in accordance with any optional form of the method of the first aspect.

The combined steps of storing and transporting in the method of the third aspect may be in accordance with the method of transporting of the second aspect, optionally in accordance with any optional features thereof.

In a fourth aspect, there is provided a plurality of storage pipes configured to store ethane therein as a liquid at ambient temperature conditions. Optionally, the storage pipes comprise ethane therein as a liquid at ambient temperature conditions.

The plurality of storage pipes of the fourth aspect may be in accordance with the plurality of storage pipes discussed in connection with the above aspects, and may be in accordance with any optional form thereof.

In a fifth aspect of the invention, there is provided a transportation vehicle, optionally a ship, vessel and/or tanker, comprising the plurality of storage pipes of the fourth aspect, optionally in any optional form thereof. The transportation vehicle of the fifth aspect may be in accordance with the transportation vehicle discussed above in connection with any of the above aspects.

In a sixth aspect of the invention, there is provided a facility, optionally an offshore floating facility, comprising a plurality of storage pipes in accordance with the fourth aspect of the invention, optionally in accordance with any optional form thereof.

The facility of the sixth aspect of the invention may be in accordance with the facility discussed above in connection with any of the above aspects.

In a seventh aspect of the invention, there is provided a system comprising: a dry gas pipeline; at least one of: a transportation vehicle in accordance with the fifth aspect and a facility in accordance with the sixth aspect; and an injection apparatus arranged to inject liquid ethane at ambient temperature conditions into the dry gas pipeline from the transportation vehicle or the facility.

The dry gas pipeline, the transportation vehicle and/or the facility of the seventh aspect may be in accordance with the correspondent features discussed above in connection with any of the first to sixth aspects.

Certain preferred embodiments of the invention will now be described, by way of example only, and with reference to the following figures, in which:

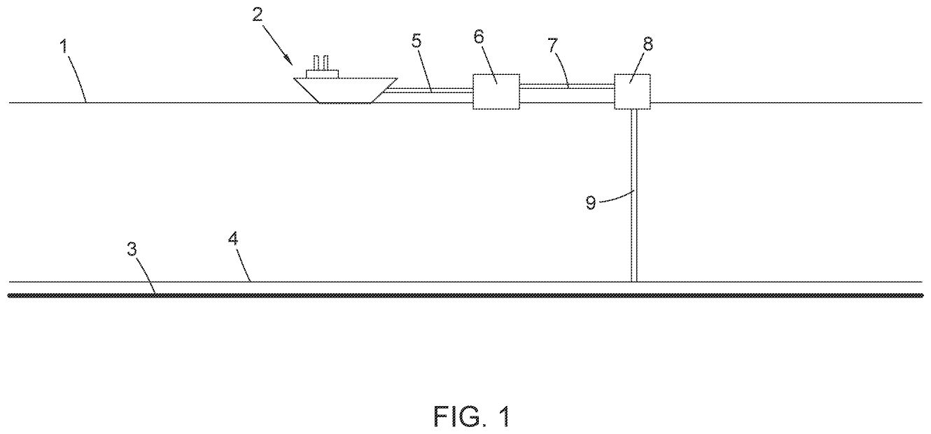

FIG. 1 is a schematic of a system comprising a tanker, an offshore floating facility and an offshore subsea dry gas pipeline; and

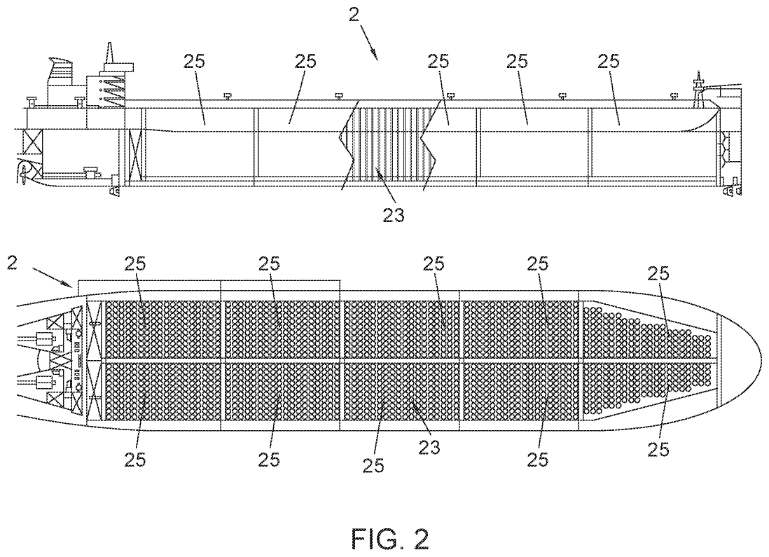

FIG. 2 shows the tanker of FIG. 1 in greater detail.

FIG. 1 depicts a system in an offshore setting, the offshore system comprising a subsea dry gas pipeline 4 running along the seabed 3. The system further comprises a tanker 2 floating at sea level 1 above (i.e. at a site) of the subsea dry gas pipeline 4. Further details of the tanker are described below with reference to FIG. 2.

The tanker 2 is positioned adjacent an offshore floating facility 6 and is releasably connected thereto via a conduit 5. The offshore floating facility 6 itself is situated adjacent a floating turret 8 and is connected to the turret 8 via conduit 7. The turret 8 is connected to a riser 9 which extends downwardly from the turret 8 and connects to the pipeline 4.

The tanker 2 as can be seen in FIG. 2, comprises a plurality (several hundred) storage pipes 23 divided between several cargo holds 25 on the tanker 2. The storage pipes 23 are vertically arranged on-board the tanker 2 and are configured to store liquid ethane therein at ambient temperature conditions and at pressures of approximately between 40 barg-45 barg (the exact pressure of storage being dependent on the ambient temperature conditions). Each storage pipe 23 is formed from a section of pipe having an X52 specification and that is sealed at either end via a suitable hemispherical cap.

The offshore floating 6 facility, whilst not shown in FIG. 1, also comprises a plurality of storage pipes that are correspondent to the storage pipes 23 provided on the tanker 2. The plurality storage pipes on the offshore floating facility 6 are thus vertically arranged and are configured to store liquid ethane therein at ambient temperature conditions and at pressures of between 40 barg-45 barg (the exact pressure of storage being dependent on the ambient temperature conditions). Each storage pipe on the offshore floating facility 6 is formed from a section of pipe having an X52 specification and that is sealed at either end via a suitable hemispherical cap.

The turret 8 comprises a booster pump (not shown). The function of the booster pump will become clear from the below discussion. A static mixer (not shown) is also provided at the interface between the riser 9 and the pipeline 4. Again, the function of the static mixer will become apparent from the below.

The system as depicted in FIG. 1 is used to enhance the energy content of the dry gas passing through the subsea dry gas pipeline 4. This is achieved by injecting ethane into the dry gas flowing within the pipeline 4 which, as will be appreciated, increases its energy content.

This process involves the tanker 2 travelling to a site remote from the dry gas pipeline 4 to collect a volume of ethane (e.g. from a hydrocarbon production system situated remote from the dry gas pipeline). The ethane is liquefied at ambient temperature conditions at between 40 barg to 45 barg and is then loaded into the storage pipes 23 on the tanker 2 for storage therein as an ambient temperature liquid. Once the storage pipes 23 have been filled, the tanker 2 then travels to a site of the dry gas pipeline 4 where it attaches to the conduit 5 to thereby connect to the offshore floating facility 6 (e.g. as shown in FIG. 1). Once the conduit 5 has been attached to the tanker 2, the liquefied ethane stored within the storage pipes 23 is offloaded from the tanker 2 to the storage pipes on-board the offshore floating facility 6. Once the storage pipes 23 have been emptied of liquid ethane, the conduit 5 is detached from the tanker 2 and the tanker 2 is then permitted to travel away from the site, e.g. to pick up a further load of ethane.

The offshore floating facility 6 acts as a buffer storage of ethane for injection into the dry gas pipeline 4 and provides an effectively continuous supply of ethane thereto. The liquid ethane at ambient temperature conditions stored within the pipes aboard the offshore floating facility 6 is transferred to the turret 8 via the conduit 7. At the turret 8, the liquid ethane (at a pressure of 40 barg to 45 barg) is further pressurised to a pressure of 180 barg using the booster pump. This permits injection of the ethane into the dry gas pipeline 4, where the dry gas is flowing at a pressure of 180 barg under the influence of a compressor. Once pressurised by the booster pump, the ethane is then injected via the riser 9 into the dry gas pipeline 4. On entry into the dry gas pipeline 4, the liquid ethane passes through the static mixer which promotes vaporisation and blending of the ethane within the dry gas flowing through the pipeline 4.

After injection, the ethane content of the dry gas in the pipeline 4 is increased which, in turn, increases the energy content of the gas within the pipeline.

The offshore floating facility 6 provides a buffer storage of ethane for effective continuous injection as noted above. The offshore floating facility however is not required in all embodiments of the invention, e.g. where continuous injection of ethane is not required or where the frequency of tankers 2 travelling to the site of the dry gas pipeline is sufficient to meet the continuous demands of injection. Thus, the offshore floating facility 6 may be entirely omitted and injection may occur directly from the tanker 2 to the pipeline 4.

We claim:

1. A method of storing ethane, the method comprising storing ethane in a plurality of storage pipes as a liquid at ambient temperature conditions.

2. A method as claimed in claim 1, wherein the ambient temperature conditions are between 0° C. to 40 ° C.

3. A method as claimed in 1, wherein the liquid ethane is stored at pressure conditions between 35 barg to 49 barg.

4. A method as claimed in claim 1, wherein each of the storage pipes has a nominal diameter of between 40 inches-60 inches (1.0 m-1.5 m), and/or wherein each storage pipe has a length of 10 m to 30 m.

5. (canceled)

6. A method as claimed in claim 1, where each of the storage pipes comprises an X452, X46, X52, X56, X60, X65, X70 or X80 pipe in accordance with the API SPEC 5L specification.

7. A method as claimed in claim 1, wherein each of the storage pipes is formed from a rolled pipe with, a single longitudinal seam.

8. A method as claimed in claim 1, wherein the plurality of storage pipes is provided on a transportation vehicle, wherein the transportation vehicle is a ship, vessel and/or tanker.

9. (canceled)

10. A method of transporting ethane, the method comprising storing ethane as claimed in accordance with claim 8, and transporting the ethane with the vehicle.

11. A method of enhancing hydrocarbon production, the method comprising:
transporting ethane in accordance with claim 10 to a site of a dry gas pipeline; and
injecting the ethane into the dry gas pipeline.

12. A method as claimed in claim 11, wherein the step of injecting the ethane into the dry gas pipeline comprises directly injecting the ethane from the transportation vehicle to the dry gas pipeline.

13. A method as claimed in claim 11, comprising offloading the ethane from the transportation vehicle to a second plurality of storage pipes provided at a storage facility situated at the site of the dry gas pipeline, storing the ethane as a liquid at ambient temperature conditions in the second plurality of storage pipes at the storage facility, and wherein the step of injecting the ethane into the dry gas pipeline comprises injecting the ethane from the plurality of storage pipes at the storage facility and into the dry gas pipeline.

14. A method according to claim 11, wherein the step of injecting ethane into the dry gas pipeline comprises pumping the ethane into the dry gas pipeline with a booster pump.

15. A method as claimed in claim 11, wherein injecting the ethane into the dry gas pipeline comprises static mixing of the ethane with the dry gas in the dry gas pipeline.

16. A method as claimed in claim 11, wherein the dry gas pipeline is an offshore dry gas pipeline and wherein the transportation vehicle is a ship, vessel and/or tanker.

17. A plurality of storage pipes configured to store ethane therein as a liquid at ambient temperature conditions.

18. A plurality of storage pipes according to claim 17, comprising liquid ethane at ambient temperature conditions stored within the plurality of storage pipes.

19. A transportation vehicle comprising a plurality of storage pipes as claimed in claim 17.

20. A transportation vehicle according to claim 19, wherein the transportation vehicle is a ship, vessel and/or tanker.

21. A storage facility comprising a plurality of storage pipes as claimed in claim 17.

22. A storage facility as claimed in claim 21, wherein the storage facility is an offshore floating storage facility.
